(19) United States
(12) Patent Application Publication
(10) Pub. No.: US 2007/0101381 A1
(43) Pub. Date: May 3, 2007

(54) IP remote

(75) Inventors: Jeff Furlong, Grand Bay-Westfield (CA); Martin C. Beckwith, Grand Bay-Westfield (CA); Robert J. Beaton, Apohaqui (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/264,131

(22) Filed: Nov. 2, 2005

(51) Int. Cl. H04N 7/173

(52) U.S. Cl. 725/105

(57) ABSTRACT

A remote control device provides commands and options based on the configuration of components in a user's environment, and based on a defined user activity. A storage device contains a user profile that includes the configuration of components at the user's environment, and defined set of user activities, such as “watching television”, “viewing a movie”, “watching a sports program”, and so on. Each user activity has a corresponding mapping of keys on the remote control device to facilitate the user activity. When the user identifies a preferred activity, the remote control device communicates commands to the components of the system to support the activity, and subsequently communicates commands to each component corresponding to this activity. A user may define multiple user activities, and the storage device may contain configurations and activities from multiple users.

### FIELD OF THE INVENTION

The invention is directed to communication networks and in particular to an IP remote application.

### BACKGROUND OF THE INVENTION

The long-promised dream of a home-wide network that allows gadgets to seamlessly interconnect is becoming a reality. As the personal electronic equipment (both mobile and home-based), also known as consumer electronics CE, evolves, the industry trend is to enable customers with digital home networks that are simple and affordable for users so the connected home experience becomes a mainstream experience for users and great opportunity for the industry. Products based on a new home networking specification backed by some of the world's largest consumer electronics and computer companies such as Fujitsu, HP, Intel, IBM, Keenwood, NEC personal products, Nokia, Panasonic, Philips, Samsung, Sharp, Sony, TI, are already on store shelves. The specification was drawn up by a group called the Digital Living Network Alliance (DLNA).

Reaching a cross-industry consensus, DLNA has defined two major components: the media server and media-rendering device that are necessary for seamless interoperability among devices accessing a home network. The interoperability guidelines drafted by DLNA define the design principles necessary to move content from one consumer electronics, personal computer or mobile product to another in a wired or wireless home network. Part of the reason for the fast pace of preparing the specification is its reliance on existing standards; DLNA uses widely accepted specifications to encourage adoption within CE, PC and mobile product manufacturing industries. The first version calls for a home network based on wired or wireless Ethernet and running IPv4 (Internet Protocol version 4), TCP (transmission control protocol), UDP (user datagram protocol). Media is carried across the network using HTTP (Hypertext Transfer Protocol) and discovery. Wi-Fi protocol is also used for enabling wireless interconnectivity.

A new version of the DLNA specification intends to cover a number of optional media formats, including GIF, PNG and TIFF images, MP3, Windows Media Audio, AC-3, AAC and ATRAC3, plus audio and the MPEG4 Part 2, MPEG4 Part 10 and Windows Media Video 9 video formats. The optional formats will mean no transcoding is required in the case that two devices support MP3, for example. The devices will still be required to support the mandatory formats so they can exchange data with devices that don't support the optional format in question.

Control and management of connected devices is accomplished with UPnP™ (universal plug and play). Unlike the “plug-and-play” technology that enables users to attach devices to a personal computer, UPnP is a standard that uses Internet and Web protocols to enable devices such as PCs, peripherals, intelligent appliances, and wireless devices to be plugged into a network and automatically know about each other. UPnP™ technology is supported on essentially any operating system and works with essentially any type of physical networking media, wired or wireless, providing maximum user and developer choice and great economics. Furthermore, UPnP architecture enables vendor control over device user interface and interaction using the web browser.

UpnP networking also enables a distributed, open architecture that enables seamless proximity networking in addition to control and data transfer among networked devices in the home, officce, and everywhere inbetween. Given an IP address, the first step in UPnP networking is discovery. When a device is added to the network, the UPnP discovery protocol allows that device to advertise its services to control points on the network. Similarly, when a control point is added to the network, the UPnP discovery protocol allows that control point to search for devices of interest on the network. The fundamental exchange in both cases is a discovery message containing a few, essential specifics about the device or one of its services, e.g., its type, identifier, and a pointer to more detailed information. The UPnP discovery protocol is based on the Simple service discovery protocol (SSDP). The UPnP description of a device is expressed in XML (extensible markup language) and includes vendor-specific, manufacturer information, a list of any embedded devices or services with the respective commands and parameters), as well as URLs for control, eventing, and presentation.

Device interoperability in a digital home network is however only the first step. Another important step is getting the devices to speak the same language, which in multimedia terms means to exchange data in the same format. Products can use other formats internally but must be able to transcode them to one of the base formats for interconnection purposes. In the first version of the DLNA specification the JPEG image, Liner PCM audio and MPEG2 video protocols have been set as a common base.

UpnP control messages are also expressed in XML using SOAP (Simple Object Access Protocol). If a CE device has a URL for presentation, then the control point can retrieve a page from this URL, load the page into a web browser, and depending on the capabilities of the page, allow a user to control the device and/or view device status. The degree to which each of these can be accomplished depends on the specific capabilities of the presentation page and device.

In addition, in today's digital world, setting common formats for both interconnection and files is not enough. As users of online music download services have already discovered, digital rights management (DRM) systems can stop content sharing cold even if the files are based on the same format. One system, called DTCP/IP (Digital Transmission Content Protection/Internet Protocol), is being developed by Intel, Hitachi, Sony, Toshiba and Matsushita Electric Industrial. It is intended to protect content as it is transmitted across an IP network like that used by DLNA products. Developers of the system are working with DRM owners on transcoding that would also allow sharing of content between devices that support different DRM systems—something that isn't possible at present.

However, to date there is no controller that enables user control of multiple CE's in the digital home network, specifically one that is universal, inexpensive, enables remote control and does not need to be in the line of sight of the device it is controlling.

While traditional remote controllers that use infrared radiation (IR) are inexpensive, they however require that the controlled device is enabled with an IR receiver, and line-of-sight is required. In addition, since the CE devices have their own IR codes, a separate remote control is needed for each. Universal remote controllers available today are rather complex, control only a limited number of devices and still require line-of-sight.

Line-of-sight is not required by the Ultra High Frequency (UHF) remote controllers available today. However, these devices are expensive, limited in the distance to the CE they can control (may require a remote extender). Also, UHF remote controllers are not universal, since not all CE devices are equipped with UHF receivers.

In addition, the traditional remote controllers are not provided with visual means (display) for viewing the status of a respective CE device currently controlled, and transmitting commands using the display. This type of control is possible only for the CE devices that have an URL for presentation, but not from the remote.

U.S. Patent Application, publication Number 20050110909, entitled “Digital remote control device” (Staunton et al.) describes a remote control device with a display. This remote control is used only for downloading video and/or supplemental textual data received by a television receiving apparatus. However, this remote controller is not universal, in that is able to communicate only with TV sets, requires a specific system controller built in the TV set and is only enabled to download data from the TV set.

U.S. Patent Application, publication Number 20030120831, entitled: “Activity-based remote control device” (Dubil et al) describes a remote controller with a display that provides commands and options based on the configuration of components in a user's environment, and based on a defined user activity. The functionality of interface buttons shown on the remote's display changes depending on the control application, i.e. the remote is system and activity aware. However, in order for this remote to function accordingly, an application is provided for a personal PC where the user is required to preconfigure the user profiles and activities in a table format. Once this is completed, the application compiles the table and then is available to download to the remote control device. The disadvantage to this is that the consumer is required to have a PC and be able to run/use the software application to configure the remotes user profiles and activities. This remote control device is not targeted for the average consumer.

There is a need to provide a universal remote controller for controlling any type of consumer electronic devices that is connected to an IP network, and in particular to a digital home network interconnecting CE devices such as televisions, set-top boxes, access to program guides, etc. There is also a need for a remote controller that is inexpensive and does not need to be in the line-of-sight of the device it is controlling.

### SUMMARY OF THE INVENTION

It is an object of the invention to provide a remote controller for controlling CE devices connected over a communication network that alleviates totally or in part the drawbacks of the existing remote controllers.

It is another object of the invention to provide a remote controller that is universal, in that can control any type of CE device connected to the network, is inexpensive and does not need to be in the line-of-sight of the device it is controlling.

Accordingly, the invention is directed to an IP remote for controlling operation of a plurality of devices connected over a digital in-home network for in-home distribution of multimedia content, comprising: a housing with a flat front face; a display provided on said front face, for showing a user-specified view with a plurality of graphic objects representing controls available to a user; means for enabling selection on said display of a device from said plurality of devices; and an electronics unit for configuring said graphic objects for said view according to the type and features of said device and for directing said device to execute a command activated on said view.

The invention is also directed to a home entertainment system for in-home distribution of multimedia content, comprising: a digital in-home network, for connecting a plurality of devices for centralized playback control; a gateway for enabling connection of said digital in-home network to the Internet for receiving multimedia content; and an IP remote for controlling any device connected over said digital in-home network through a set-top-box.

Advantageously, the remote control of the invention is flexible, in that it is unlimited in the amount of control that it offers and the CE devices it can control. The IP Remote of the invention requires no additional software to be installed on any client device, since its functions are managed from and created on the remote control device. The IP Remote is designed to target all consumers in that it provides simple, basic functionality for the average user and it also has the ability for advanced users to create advanced command sets.

[JLF1]

Advantageously, the IP Remote provides an ideal solution to a multi-decode set-top box.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 shows an example of a digital home network using the IP remote of the invention;

FIG. 2 illustrates an example of one of the views that can be displayed by the IP remote according to the invention; and

FIG. 3 is a block diagram of the IP remote according to an embodiment of the invention.

### DETAILED DESCRIPTION

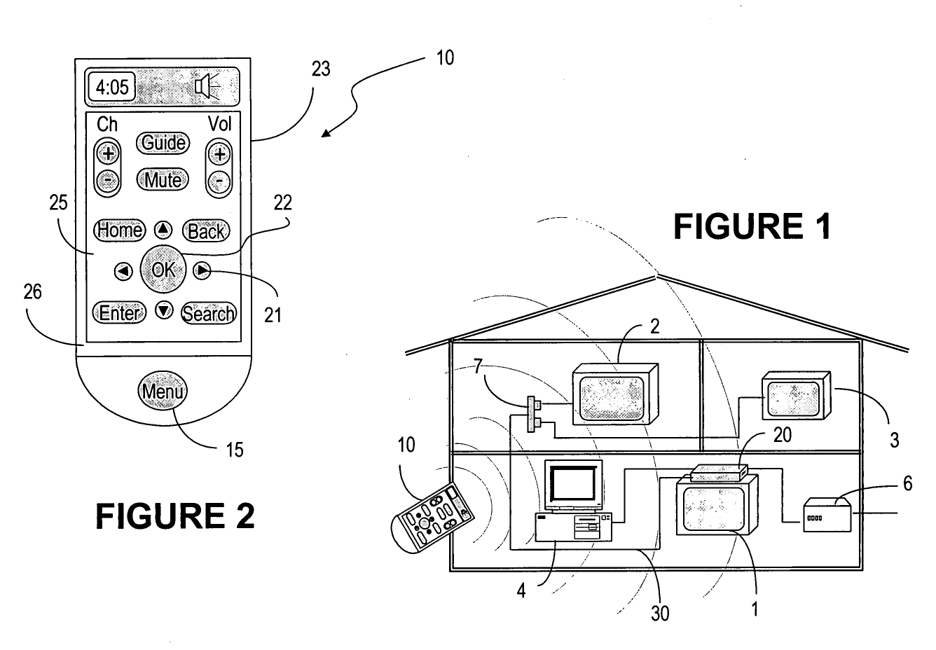

FIG. 1 shows an example of a digital home network 30 for in-home distribution of multimedia (video, audio, data) content, that connects a plurality of video, audio or data terminals such as TVs 1 2, 3, computers 4, etc. (collectively referred to as “devices”), communicatively connected to a set-top box (STB) 20. The in-home network 30 may also include splitters 7 as needed, for attaching all the devices to a specific port of the STB. FIG. 1 also shows that STB 20 is connected to a communication network (not shown) over a gateway 6, using any adequate technology (digital subscriber loop DSL, fiber to the home FTTH, etc.) for receiving any multimedia entertainment content of interest to the respective subscriber. [JLF2]

[JLF3] The IP remote 10 according to the invention obtains an IP address from the home gateway 6 and uses the wireless network within the home to communicate with devices. In this case the IP Remote, once an IP address is obtained, uses UPnP to discover the STB 20 and gathers all relevant information on how to control the STB 20. Once this is obtained, the IP remote 10 is now configured to control the STB 20.

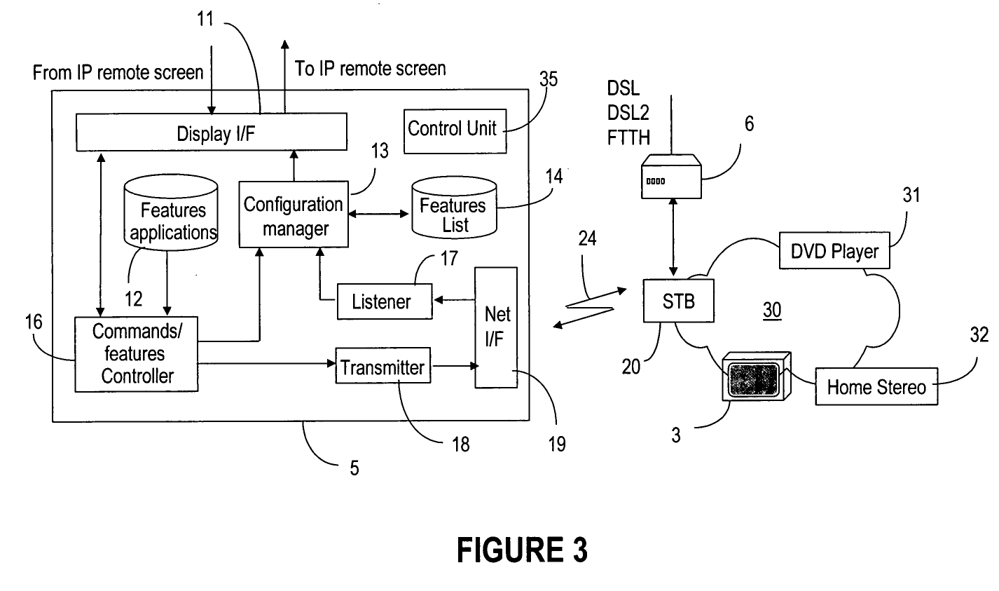

FIG. 2 illustrates an example of one embodiment of the IP remote according to the invention. In the example of FIG. 2, the IP remote 10 has a flat housing 23 for the electronics unit 5 (see FIG. 3), and a large display (screen) 25. Also, the IP remote 10 of the example of FIG. 2 also has a menu button 15 for enabling the user to view and select a device of interest on screen 25.

It is to be noted that the shape of the housing 23 is not relevant to the invention as long as it can accommodate on the front face 26 the screen 25. In addition, the functionality of the menu button 15 is not limited to device selection, other menus may be displayed to enable the user selection of a command or feature. The term “view” is used here to identify a particular graphic shown on the screen of the IP remote. [JLF4] The term “features”, or “command” is used to specify the controls applicable to the devices. The virtual buttons appearing on the display of the IP remote are referred to as “controls”.

Once a view has been selected the features/controls available for the respective view are displayed on screen 25. The screen may display a device-specific view with the controls available for a respective device; the user may now press any button for controlling the operation of the respective device. The IP Remote has the ability to send key commands to devices over a secured TCP/IP network. For example, the IP remote of FIG. 2 displays the control buttons for a STB, whereby the user may scan channels, request viewing the program guide, increase/decrease the volume, etc.

Each device has a specified dedicated port [JLF7] which it will listen and retrieve key commands. The content of the key command message will contain the device ID (or name), the key command, and any extra options that are supported by the device. A key command may include a value, a word representing the command (i.e. RECORD), or a string of multiple commands (i.e. RECORD CHANNEL 4 AND TURN OFF TV).

The screen may also show a more generic view for enabling the user to request one or more devices connected over the network to perform a sequence of functions/commands involving operation of a plurality of devices. On such a generic view, a user may send multiple commands to multiple devices, such as for example STB1 RECORD CHANNEL 4 AND STB2 RECORD CHANNEL 5 AND STEREO TUNE TO 94.1 FM. The remote may also be programmed to perform a succession of operation involving one or more devices. For example, STB1 RECORD CHANNEL 4 AND TURN OFF TV. In addition, the commands may be timed if needed.

It is to be noted that since the IP Remote 10 is a software application, it allows for easy upgrades and can easily support multi-decode set-top boxes, by adequately re-configuring the respective interface. Also, since any type of screen can be generated, the IP remote offers an unlimited amount of control, and an unlimited number and type of the devices it can control. A virtual remote control is also possible; this can run on a laptop, PC, etc. As well, since it communicates with the STB 20 over a wireless link, no line-of-sight is required, the user being able to control the devices on the in-home network 30 from any point within the house or the neighborhood.

As indicated above, the IP Remote is preferably based on the DLNA Specification, which means it is able to auto-discover other devices and detect what features are supported by the respective devices. Auto-configuration can be performed through UPnP. When connected to the in-home network, [JLF11] will populate a list of all devices that are connected to the network, and will provide the ability to select which device to control.

The IP Remote can also be manually configured to support any devices that are not part of the DLNA Specification. Preferably, 802.11b is used as the primary choice for network connectivity but obviously it can be designed to work on any network.

FIG. 3 shows a block diagram of the IP remote 10 according to an embodiment of the invention. The IP remote includes and interface 11 with the IP remote display, which is preferably an LCD (Liquid Crystal Display) interface, Interface 11 converts the data received from electronics 5 into graphics objects representing the buttons on the screen 25, and also translates the commands activated by the users on the screen 25 into control signals. A network interface 19 sends commands entered by the user over the in-home network. A listener 17 operates to discover the devices connected to network 20. Once a device is discovered, the listener 17 transmits the device identity to a configuration manager 13 that configures the controls available for the respective device, by consulting a memory 14. Memory 14 maintains a list with all commands/features available for all devices that may be connected over in-home network 30. The configuration manager uses this list for preparing the view for the respective device, by associating the commands/features with the respective device identity collected by the listener 17.

For example, if the user selected on the menu view the STB 20, the configuration manager will recognize the device as being an STB, will collect from list 14 all controls/features applicable to the STB and will prepare the view shown in the example of FIG. 2. It is to be noted that it is also possible to have different views for different types of STB's, according to the model (ex. PVR and non-PVR models). In such a case, the listener must also provide the device type to the configuration manager.

The IP remote also includes a commands/features controller 16 that receives the respective control data from the screen over interface 11 and executes the operations necessary for the respective control/feature. A database 12 illustrates the repository for all subroutines corresponding to the operations that can be performed by the devices. Once the command is identified and the application is extracted from memory 12 and the commands controller sends the respective command or sequence of commands, or multiple commands to the devices, using a transmitter[JLF12], which transmits (or sends) the key command(s) over the in-home network (via. software) to the specified device. 18.

We claim:

1. An IP remote for controlling operation of a plurality of devices connected over a digital in-home network for in-home distribution of multimedia content, comprising:
a housing with a flat front face;
a display provided on said front face, for showing a user-specified view with a plurality of graphic objects representing controls available to a user;
means for enabling selection on said display of a device from said plurality of devices; and
an electronics unit for configuring said graphic objects for said view according to the type and features of said device and for directing said device to execute a command activated on said view.

2. The IP remote of claim 1, wherein said electronics unit comprises:
means for configuring said view to show a set of graphic objects corresponding to a set of features available for said device; and
means for executing a user-selected feature displayed on said view.

3. The IP remote of claim 2, wherein said means for configuring comprises:
a first memory for storing a feature list with a plurality of features available for a all devices connected to said digital in-home network;
a configuration manager for generating a set of features available for said device based on the identity of said device, and for configuring said view to show a set of graphic objects corresponding to said features.

4. The IP remote of claim 3, wherein said means for configuring further comprises a listener for discovering all devices connected to said digital in-home network and transmitting the identity of all said devices to said configuration manager.

5. The IP remote of claim 4, wherein device identity comprises a device address on said digital in-home network and the device type.

6. The IP remote of claim 4, wherein device identity comprises a device address on said digital in-home network, the device type and the device model.

7. The IP remote of claim 2, wherein said means for executing comprises:
a second memory for storing a plurality of feature applications corresponding to said features available in a feature list;
a display interface for transmitting to said feature controller a user-selected command corresponding to a control selected on said view;
a features controller for accessing a feature application corresponding to said user-selected command and for executing said command; and
a transmitter for transmitting said command to said device over a network interface.

8. The IP remote as claimed in claim 7, wherein said network interface is a wireless interface, so that no line-of sight between said IP remote and said device is necessary.

9. The IP remote of claim 1, wherein said display is a LCD display.

10. A home entertainment system for in-home distribution of multimedia content, comprising:
a digital in-home network, for connecting a plurality of devices for centralized playback control;
a gateway for enabling connection of said digital in-home network to the Internet for receiving multimedia content; and
an IP remote for controlling any device connected over said digital in-home network[JLF13].

11. A system as claimed in claim 10, wherein said devices are DNLA compatible and use universal plug-and-play technology, for automatically providing said IP remote with a respective identity and feature information.

12. A system as claimed in claim 10, wherein said IP remote is manually provided with a respective identity and feature information for a device added to said digital in-home network.

13. A system as claimed in claim 10, wherein said digital in-home network enables connection of new devices using universal plug and play (UPnP) technology.

14. The system of claim 10, wherein said digital in-home network uses 802.11b for network connectivity.
